(19) United States
(12) Patent Application Publication
(10) Pub. No.: US 2026/0270804 A1
(43) Pub. Date: Sep. 10, 2026

(54) METHODS AND APPARATUS FOR STORING THE CONTEXT OF A USER EQUIPMENT IN A DATABASE DURING A CHANGE IN RADIO RESOURCE CONTROL STATE

(71) Applicant: Nokia Technologies Oy, Espoo (FI)

(72) Inventors: Guillaume DECARREAU, Munich (DE); Mohammad SOLIMAN, Munich (DE)

(21) Appl. No.: 19/163,697

(22) PCT Filed: Mar. 20, 2023
(86) PCT No.: PCT/US2023/015666

§ 371 Date: Sep. 9, 2025

(51) Int. Cl. H04W 36/00; H04W 12/041; H04W 12/106

(52) U.S. Cl. CPC H04W 36/0038; H04W 12/041; H04W 12/106

(57) ABSTRACT

Techniques are provided for facilitating the switching of a radio resource control (RRC) state of a user equipment (UE) with a source base station and at least one target base stations. In the context of a method performed by the source base station, the method determines that a RRC state of a UE should be changed. The method also includes causing a context of the UE and a security key to be transmitted to at least one database. The method also includes receiving an inactive UE identifier from the database. The method also includes instructing the UE to change the RRC state to an inactive state. Corresponding methods, apparatuses and computer-readable storage mediums are also provided for a UE, a database, and a target base station.

### TECHNOLOGICAL FIELD

An example embodiment relates generally to techniques for facilitating wireless communication and, more particularly, to techniques for storing the context of a user equipment within a database and identifying the user equipment by an inactive user equipment identifier to allow for a change in the radio resource control station.

### BACKGROUND

Two connection management states are defined by the 3rd generation partnership project (3GPP) specifications, namely, the CM-IDLE and CM-CONNECTED states. Furthermore, two radio resource control (RRC) states are defined within the CM-CONNECTED state, namely, the RRC_CONNECTED and RRC_INACTIVE states. The RRC_INACTIVE state was introduced in fifth generation (5G) networks to maintain power saving features while decreasing the delay of state change whenever data is required to be transmitted.

While in the RRC_INACTIVE state, the UE context is either stored by the last serving gNB or transmitted to another gNB within the radio access network (RAN)-based Notification Area (RNA) within which the UE can move without notifying the network. While in the RRC_Inactive state, when the UE is paged or is otherwise required to transmit uplink data, the UE sends a RRCResumeRequest message containing a temporary inactive identifier, namely, inactive radio network temporary identification (I-RNTI) and a message authentication code—integrity (MAC-I), to the target gNB. In case of mobility, the target gNB is possibly different from the last serving gNb. The target gNB uses the I-RNTI to identify the last serving gNB. Next, the target gNB requests the UE context from the last serving gNB via the Xn interface. In doing so, the MAC-I is sent together with the I-RNTI so that the last serving gNB can certify that the request is legitimate. Finally, the target gNB sends a RRCResume message to the UE to change the state from RRC_INACTIVE to RRC_CONNECTED. Only at this point, the target gNB sends a UE Context Release Request to the source gNB.

When the UE changes state to RRC_INACTIVE, the UE context is maintained in the last serving gNB. The last serving gNB keeps the resources allocated for the UE until a UE Context Release message is received from the target gNB. This means that resources are allocated for the UE even when the UE leaves the serving area of the gNB. Alternatively, the source gNB may decide to store the UE context in different entity, such as a database or another gNB.

The IRNT-I consists of information regarding the last serving gNB. If the last serving gNB decides to store the UE context in a different entity (e.g., database or another gNB), this entity must maintain the UE ID to ensure ID availability when the UE sends a RRCResumeRequest message. The last serving gNB that sends the UE to the RRC_INACTIVE state might allocate duplicate UE IDs. If the gNB creates a new ID each time the UE state is changed to inactive, it may be difficult to ensure the availability of the ID for the UE in that it is difficult to determine whether the ID it already assigned to another UE by the database or by another gNB.

Additionally, when the UE changes state from the RRC INACTIVE state to the RRC_CONNECTED state, the UE sends a MAC-I field in the RRCResumeRequest message. This MAC-I is generated using the last serving gNB key. The key of the last serving gNB is used by the entity holding the UE context to authenticate the UE. However, if the UE context is stored in a different entity than the source gNB, the different entity would not be able to authenticate the UE because the different entity does not know the key used to generate the MAC-I.

### BRIEF SUMMARY

A method, apparatus and computer program product are provided in accordance with an example embodiment in order to facilitate an efficient transition between the RRC_Connected and RRC_Inactive states. In this regard, the method, apparatus and computer program product provide for the context of the UE to be maintained by a database while the UE is in the RRC_Inactive state. The database may be referenced by a base station in conjunction with a transition from the RRC_Inactive state to the RRC_Connected state, even in an instance in which the UE is served by a different base station during the transition from the RRC_Inactive state to the RRC_Connected state than the base station that served the UE at the time that the UE previously transitioned to the RRC_Inactive state. By storing the UE context in a database, the last serving base station can delete the UE context such that the last serving base station no longer needs to maintain the resources allocated for the UE, while still ensuring that the UE can efficiently return to the RRC_Connected state at a subsequent point in time while served by the different base station. Additionally, the method, apparatus and computer program product of an example embodiment provide for the UE to be identified in such a manner that the last serving base station need not keep track of identifiers that have been previously utilized in conjunction with UEs in an RRC_Inactive state, thereby improving the efficiency with which the last serving base station operates.

In an example embodiment, a method is provided that includes determining that a radio resource control state of a user equipment should be changed. The method also includes causing a context of the user equipment and a security key to be transmitted to at least one database. The method also includes receiving an inactive user equipment identifier from the at least one database. The method further includes instructing the user equipment to change the radio resource control state to an inactive state. In some embodiments, instructing the user equipment to change the radio resource control state may comprise causing the inactive user equipment identifier to be provided to the user equipment.

The method of an example embodiment may also include causing a request for the inactive user equipment identifier to be provided to the at least one database. In this example embodiment, the inactive user equipment identifier may comprise an identifier of the at least one database. In this example embodiment, the method may also include removing the context of user equipment from memory after instructing the user equipment to change the radio resource control state to the inactive state. In this example embodiment, instructing the user equipment to change the radio resource control state to the inactive state comprises causing information regarding derivation of a security key to be provided to the user equipment. In this example embodiment, the inactive state may comprise an RRC_INACTIVE state of a CM-CONNECTED state.

In another example embodiment, an apparatus is provided that includes at least one processor and at least one memory storing instructions that, when executed by the at least one processor, cause the apparatus to at least determine that a radio resource control state of a user equipment should be changed. The apparatus is also caused to cause a context of the user equipment and a security key to be transmitted to at least one database. The apparatus is also caused to receive an inactive user equipment identifier from the at least one database. The apparatus is also caused to instruct the user equipment to change the radio resource control state to an inactive state by causing the inactive user equipment identifier to be provided to the user equipment.

The apparatus of an example embodiment may be further caused to request for the inactive user equipment identifier to be provided to the at least one database. In this example embodiment, the inactive user equipment identifier may comprise an identifier of the at least one database. In this example embodiment, the apparatus may be further cause to remove the context of user equipment from memory after instructing the user equipment to change the radio resource control state to the inactive state. In this example embodiment, the apparatus may be further caused to instruct the user equipment to change the radio resource control state to the inactive state by causing information regarding derivation of a security key to be provided to the user equipment. In this example embodiment, the inactive state may comprise an RRC_INACTIVE state of a CM-CONNECTED state.

In a further example embodiment, a non-transitory computer-readable storage medium is provided that includes program instructions stored thereon for determining that a radio resource control state of a user equipment should be changed. The program instructions are also configured to cause a context of the user equipment and a security key to be transmitted to at least one database and to receive an inactive user equipment identifier from the at least one database. The program instructions are further configured to instruct the user equipment to change the radio resource control state to an inactive state. In some embodiments, program instructions configured to instruct the user equipment to change the radio resource control state may comprise program instructions configured to cause the inactive user equipment identifier to be provided to the user equipment.

The computer-readable storage medium of an example embodiment may also include program instructions configured to cause a request for the inactive user equipment identifier to be provided to the at least one database. In this example embodiment, the inactive user equipment identifier may comprise an identifier of the at least one database. In this example embodiment, the computer-readable storage medium may also include program instructions configured to remove the context of user equipment from memory after instructing the user equipment to change the radio resource control state to the inactive state. In this example embodiment, the program instructions configured to instruct the user equipment to change the radio resource control state to the inactive state comprise program instructions configured to cause information regarding derivation of a security key to be provided to the user equipment. In this example embodiment, the inactive state may comprise an RRC_INACTIVE state of a CM-CONNECTED state.

In yet another example embodiment, an apparatus is provided that includes means for means for determining that a radio resource control state of a user equipment should be changed. The apparatus may also include the means for causing a context of the user equipment and a security key to be transmitted to at least one database. The apparatus may also include the means for means for receiving an inactive user equipment identifier from the at least one database. The apparatus may further include the means for instructing the user equipment to change the radio resource control state to an inactive state.

The apparatus of an example embodiment may further comprise means for causing a request for the inactive user equipment identifier to be provided to the at least one database. In this example embodiment, the inactive user equipment identifier may comprise an identifier of the at least one database. In this example embodiment, the apparatus may further comprise means for removing the context of user equipment from memory after instructing the user equipment to change the radio resource control state to the inactive state. In this example embodiment, the apparatus may further comprise means for instructing the user equipment to change the radio resource control state to the inactive state comprises means for causing information regarding derivation of a security key to be provided to the user equipment. In this example embodiment, the inactive state may comprise an RRC_INACTIVE state of a CM-CONNECTED state.

In an example embodiment, a method is provided that includes receiving instructions to change a radio resource control state to an inactive state. The instructions comprise an inactive user equipment identifier. The method also includes configuring the user equipment to switch to the inactive state. The method also includes causing a radio resource control connect request to be transmitted to a target base station along with the inactive user equipment identifier and a message authentication code. The method also includes changing the radio resource control state to a connected state in response to direction from the target base station.

The method of an example embodiment also includes generating the message authentication code using a security key. In this example embodiment, the instructions may further comprise information regarding derivation of the security key. In this example embodiment, the message authentication code may be generated using at least one of: the inactive user equipment identifier, a source base station identifier, or a target base station identifier. In this example embodiment, the method may also include receiving the direction to change the radio resource control state to the connected state.

In another example embodiment, an apparatus is provided that includes at least one processor and at least one memory storing instructions that, when executed by the at least one processor, cause the apparatus at least to receive instructions to change a radio resource control state to an inactive state. The instructions may comprise an inactive user equipment identifier. The apparatus is also caused to configure the user equipment to switch to the inactive state. The apparatus is also caused to cause a radio resource control connect request to be transmitted to a target base station along with the inactive user equipment identifier and a message authentication code. The apparatus is also caused to change the radio resource control state to a connected state in response to direction from the target base station.

The apparatus of an example embodiment is also caused to generate the message authentication code using a security key. In this example embodiment, the instructions may further comprise information regarding derivation of the security key. In this example embodiment, the message authentication code may be generated using at least one of: the inactive user equipment identifier, a source base station identifier, or a target base station identifier. In this example embodiment, the apparatus may be further caused to receive the direction to change the radio resource control state to the connected state.

In a further example embodiment, a non-transitory computer-readable storage medium is provided that includes program instructions stored thereon for receiving instructions to change a radio resource control state to an inactive state. The instructions comprise an inactive user equipment identifier. The computer-readable storage medium also includes program instructions for configuring the user equipment to switch to the inactive state. The computer-readable storage medium also includes program instructions configured to cause a radio resource control connect request to be transmitted to a target base station along with the inactive user equipment identifier and a message authentication code. The computer-readable storage medium further includes program instructions configured to change the radio resource control state to a connected state in response to direction from the target base station.

The computer-readable storage medium of an example embodiment also includes program instructions configured to generate the message authentication code using a security key. In this example embodiment, the instructions may further comprise information regarding derivation of the security key. In this example embodiment, the message authentication code may be generated using at least one of: the inactive user equipment identifier, a source base station identifier, or a target base station identifier. In this example embodiment, the computer-readable storage medium may also include program code instructions configured to receive the direction to change the radio resource control state to the connected state.

In another example embodiment, an apparatus is provided that includes at least one processor and at least one memory storing instructions that, when executed by the at least one processor, cause the apparatus at least to receive instructions to change a radio resource control state to an inactive state. The instructions may comprise an inactive user equipment identifier. The apparatus is also caused to configure the user equipment to switch to the inactive state. The apparatus is also caused to cause a radio resource control connect request to be transmitted to a target base station along with the inactive user equipment identifier and a message authentication code. The apparatus is also caused to change the radio resource control state to a connected state in response to direction from the target base station.

In yet another example embodiment, an apparatus is provided that includes means for receiving instructions to change a radio resource control state to an inactive state, wherein the instructions comprise an inactive user equipment identifier. The apparatus also includes means for configuring the user equipment to switch to the inactive state. The apparatus also includes means for causing a radio resource control connect request to be transmitted to a target base station along with the inactive user equipment identifier and a message authentication code. The apparatus may further include means for changing the radio resource control state to a connected state in response to direction from the target base station.

The apparatus of an example embodiment may further comprise means for generating the message authentication code using a security key. In this example embodiment, the instructions may further comprise information regarding derivation of the security key. In this example embodiment, the message authentication code may be generated using at least one of: the inactive user equipment identifier, a source base station identifier, or a target base station identifier. In this example embodiment, the apparatus may further comprise means for receiving the direction to change the radio resource control state to the connected state.

In a further example embodiment, a method is provided that includes receiving a context of a user equipment and a security key from a source base station. The method also includes causing an inactive user equipment identifier to be provided to the source base station. The method also includes receiving the inactive user equipment identifier from a target base station. The method further includes causing information regarding the context of the user equipment to be provided to the target base station.

The inactive user equipment identifier may comprise a database identifier. In this example embodiment, the method may also include receiving a message authentication code from the target base station in combination with the inactive user equipment identifier. In this example embodiment, the message authentication code is at least partially based on the security key. In this example embodiment, the method may also include confirming credentials of the user equipment based upon the inactive user equipment identifier and the message authentication code prior to causing information regarding the context of the user equipment to be provided to the target base station. In this example embodiment, the method may further include removing the user context for the user equipment after causing information regarding the context of the user equipment to be provided to the target base station.

In another example embodiment, an apparatus is provided that includes at least one processor and at least one memory storing instructions that, when executed by the at least one processor, cause the apparatus at least to receive a context of a user equipment and a security key from a source base station. The apparatus is also caused to cause an inactive user equipment identifier to be provided to the source base station. The apparatus is also caused to receive the inactive user equipment identifier from a target base station. The apparatus if further caused to cause information regarding the context of the user equipment to be provided to the target base station.

The inactive user equipment identifier may comprise a database identifier. In this example embodiment, the apparatus may be further caused to receive a message authentication code from the target base station in combination with the inactive user equipment identifier. In this example embodiment, the message authentication code is at least partially based on the security key. In this example embodiment, the apparatus may be further caused to confirm credentials of the user equipment based upon the inactive user equipment identifier and the message authentication code prior to causing information regarding the context of the user equipment to be provided to the target base station. In this example embodiment, apparatus may be further caused to remove the user context for the user equipment after causing information regarding the context of the user equipment to be provided to the target base station.

In a further example embodiment, a non-transitory computer-readable storage medium is provided that includes program instructions stored thereon for receiving a context of a user equipment and a security key from a source base station. The computer-readable storage medium also includes program instructions configured to cause an inactive user equipment identifier to be provided to the source base station. The computer-readable storage medium also includes program instructions configured to receive the inactive user equipment identifier from a target base station. The computer-readable storage medium further includes program instructions configured to cause information regarding the context of the user equipment to be provided to the target base station.

The inactive user equipment identifier may comprise a database identifier. In this example embodiment, the computer-readable storage medium may also include program instructions for receiving a message authentication code from the target base station in combination with the inactive user equipment identifier. In this embodiment, the message authentication code is at least partially based on the security key. In this example embodiment, the computer-readable storage medium may also include program instructions configured to confirm credentials of the user equipment based upon the inactive user equipment identifier and the message authentication code prior to causing information regarding the context of the user equipment to be provided to the target base station. In this example embodiment, the computer-readable storage medium may further include program instructions for removing the user context for the user equipment after causing information regarding the context of the user equipment to be provided to the target base station.

In yet another example embodiment, an apparatus is provided that includes means for receiving a context of a user equipment and a security key from a source base station. The apparatus also includes means for causing an inactive user equipment identifier to be provided to the source base station. The apparatus also includes means for receiving the inactive user equipment identifier from a target base station. The apparatus further includes means for causing information regarding the context of the user equipment to be provided to the target base station.

The inactive user equipment identifier that may comprise a database identifier. In this example embodiment, the apparatus may further include means for receiving a message authentication code from the target base station in combination with the inactive user equipment identifier. In this example embodiment, the message authentication code is at least partially based on the security key. In this example embodiment, the apparatus may further include means for confirming credentials of the user equipment based upon the inactive user equipment identifier and the message authentication code prior to causing information regarding the context of the user equipment to be provided to the target base station. In this example embodiment, the apparatus may further include means for removing the user context for the user equipment after causing information regarding the context of the user equipment to be provided to the target base station.

In another example embodiment, a method is provided that includes receiving a radio resource control connect request from a user equipment along with an inactive user equipment identifier and a message authentication code. The method also includes causing the inactive user equipment identifier and the message authentication code to be provided to at least one database. The method also includes receiving context of the user equipment. The method may further include causing direction to be provided to the user equipment to change the radio resource control state to a connected state.

The inactive user equipment identifier may comprise a database identifier. In this example embodiment, the message authentication code is at least partially based on the security key. In this example embodiment, the message authentication code is also at least partially based on least one of: the inactive user equipment identifier, a source base station identifier, or a target base station identifier.

In another example embodiment, an apparatus is provided that includes at least one processor and at least one memory storing instructions that, when executed by the at least one processor, cause the apparatus at least to receive a radio resource control connect request from a user equipment along with an inactive user equipment identifier and a message authentication code. The apparatus may also be caused to cause the inactive user equipment identifier and the message authentication code to be provided to at least one database. The apparatus may also be caused to receive context of the user equipment. The apparatus may be further caused to cause direction to be provided to the user equipment to change the radio resource control state to a connected state.

The inactive user equipment identifier may comprise a database identifier. In this example embodiment, the message authentication code is at least partially based on the security key. In this example embodiment, the message authentication code is also at least partially based on least one of: the inactive user equipment identifier, a source base station identifier, or a target base station identifier.

In a further example embodiment, a non-transitory computer-readable storage medium is provided that includes program instructions stored thereon for receiving a radio resource control connect request from a user equipment along with an inactive user equipment identifier and a message authentication code. The computer-readable storage medium also includes program instructions configured to cause the inactive user equipment identifier and the message authentication code to be provided to at least one database. The computer-readable storage medium also includes program instructions configured to receive context of the user equipment. The computer-readable storage medium may further include program instructions configured to cause direction to be provided to the user equipment to change the radio resource control state to a connected state.

The inactive user equipment identifier may comprise a database identifier. In this example embodiment, the message authentication code is at least partially based on the security key. In this example embodiment, the message authentication code is also at least partially based on least one of: the inactive user equipment identifier, a source base station identifier, or a target base station identifier.

In yet another example embodiment, an apparatus is provided that includes means for receiving a radio resource control connect request from a user equipment along with an inactive user equipment identifier and a message authentication code. The apparatus also include means for causing the inactive user equipment identifier and the message authentication code to be provided to at least one database. The apparatus also include means for receiving context of the user equipment. The apparatus further include means for causing direction to be provided to the user equipment to change the radio resource control state to a connected state.

The apparatus of an example embodiment may include the inactive user equipment identifier comprises a database identifier. In this example embodiment, the message authentication code is at least partially based on the security key. In this example embodiment, the message authentication code is also at least partially based on least one of: the inactive user equipment identifier, a source base station identifier, or a target base station identifier.

The above summary is provided merely for purposes of summarizing some example embodiments to provide a basic understanding of some aspects of the invention. Accordingly, it will be appreciated that the above-described embodiments are merely examples and should not be construed to narrow the scope or spirit of the disclosure in any way. It will be appreciated that the scope of the disclosure encompasses many potential embodiments in addition to those here summarized, some of which will be further described below. Other features, aspects, and advantages of the subject matter will become apparent from the description, the drawings, and the claims.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 illustrates an example of a communication system in accordance with an example embodiment of the present disclosure;

FIG. 2 illustrates a block diagram of an apparatus that may be configured in accordance with an example embodiment of the present disclosure;

FIG. 3 illustrates a block diagram of a radio resource control connection state in accordance with an example embodiment of the present disclosure;

FIGS. 4A and 4B illustrate a signal diagram in accordance with an example embodiment of the present disclosure;

FIG. 5 illustrates an example workflow implemented by a source base station in accordance with an example embodiment of the present disclosure;

FIG. 6 illustrates an example workflow implemented by a user equipment in accordance with an example embodiment of the present disclosure;

FIG. 7 illustrates an example workflow implemented by a database in accordance with an example embodiment of the present disclosure; and

FIG. 8 illustrates an example workflow implemented by a target base station in accordance with an example embodiment of the present disclosure.

### DETAILED DESCRIPTION

Some embodiments of the present invention will now be described more fully hereinafter with reference to the accompanying drawings, in which some, but not all, embodiments of the invention are shown. Indeed, various embodiments of the invention may be embodied in many different forms and should not be construed as limited to the embodiments set forth herein, rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device (such as a core network apparatus), field programmable gate array, and/or other computing device.

The term “comprising” means including but not limited to and should be interpreted in the manner it is typically used in the patent context. Use of broader terms such as comprises, includes, and having should be understood to provide support for narrower terms such as consisting of, consisting essentially of, and comprised substantially of. Furthermore, to the extent that the terms “includes” and “including,” and variants thereof are used in either the detailed description or the claims, these terms are intended to be inclusive in a manner similar to the term “comprising.”

The phrases “in one embodiment,” “according to one embodiment,” “in some embodiments,” “in various embodiments”, and the like generally refer to the fact that the particular feature, structure, or characteristic following the phrase may be included in at least one embodiment of the present disclosure, but not necessarily all embodiments of the present disclosure. Thus, the particular feature, structure, or characteristic may be included in more than one embodiment of the present disclosure such that these phrases do not necessarily refer to the same embodiment.

As used herein, the terms “example,” “exemplary,” and the like are used to mean “serving as an example, instance, or illustration.” Any implementation, aspect, or design described herein as “example” or “exemplary” is not necessarily to be construed as preferred or advantageous over other implementations, aspects, or designs. Rather, use of the terms “example,” “exemplary,” and the like are intended to present concepts in a concrete fashion.

If the specification states a component or feature “may,” “can,” “could,” “should,” “would,” “preferably,” “possibly,” “typically,” “optionally,” “for example,” “often,” or “might” (or other such language) be included or have a characteristic, that particular component or feature is not required to be included or to have the characteristic. Such component or feature may be optionally included in some embodiments, or it may be excluded.

As used herein, the term “computer-readable medium” refers to non-transitory storage hardware, non-transitory storage device or non-transitory computer system memory that may be accessed by a controller, a microcontroller, a computational system or a module of a computational system to encode thereon computer-executable instructions or software programs. A non-transitory “computer-readable medium” may be accessed by a computational system or a module of a computational system to retrieve and/or execute the computer-executable instructions or software programs encoded on the medium. Examples of non-transitory computer-readable media may include, but are not limited to, one or more types of hardware memory, non-transitory tangible media (for example, one or more magnetic storage disks, one or more optical disks, one or more USB flash drives), computer system memory or random-access memory (such as, DRAM, SRAM, EDO RAM), and the like.

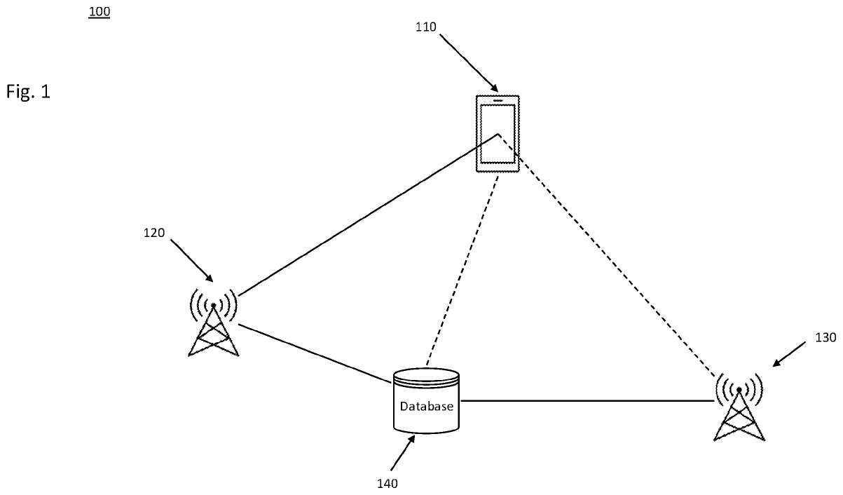

As illustrated in FIG. 1, a communication system 100 is provided in accordance with various embodiments of the present disclosure. In some embodiments, the communication system 100 may comprise at least one user equipment (UE) 110, at least one source base station 120 that is currently serving the UE (also referred to as the last serving base station), at least one target base station 130, and/or at least one database 140. The UE 110, the source base station 120, the at least one target base station 130, and/or the at least one database may be configured to operate in one or more frequency bands including, for example, the FR1 band and/or the FR2 band. Regardless of the band, the apparatus, method and computer program product of an example embodiment are configured to implement a process for supporting a change in the radio resource control (RRC) state of the UE by providing, storing, and/or retrieving the context of the UE based upon identification information, such as an inactive user equipment identifier (inactive UE ID), database identifier (DB ID), message authentication code (MAC), and/or the like, As such, the efficiency of transitioning a UE from an RRC_Inactive state to an RRC_Connected state with a base station, such as a target base station 130 is enhanced.

By way of example, the system 100 may be deployed within a radio access architecture based on long term evolution advanced (LTE Advanced, LTE-A) and/or new radio (NR, 5G). However, the system may be deployed in other network architectures including within other communication networks including, for example, other communication networks developed in the future, e.g., sixth generation (6G) networks, as well as any of a number of existing networks including a universal mobile telecommunications system (UMTS) radio access network (UTRAN, E-UTRAN or NG-RAN), wireless local area network (WLAN or WiFi), worldwide interoperability for microwave access (WiMAX), Bluetooth®, personal communications services (PCS), ZigBee®, wideband code division multiple access (WCDMA), systems using ultra-wideband (UWB) technology, sensor networks, mobile ad-hoc networks (MANETs) and Internet Protocol multimedia subsystems (IMS) or any combination thereof.

The UE 110 may be any type of user terminal, terminal device, etc. to which resources on the air interface are allocated and assigned. For example, the UE may be a portable computing device such as a wireless mobile communication device including, but not limited to, the following types of devices: a mobile station (mobile phone), smartphone, personal digital assistant (PDA), handset, device using a wireless modem (alarm or measurement device, etc.), laptop and/or touch screen computer, tablet, game console, notebook, and multimedia device. The user equipment may also be called a subscriber unit, mobile station, remote terminal, access terminal, user terminal or user equipment (UE) just to mention but a few names or apparatuses.

The base stations, such as the source base station 120 and the at least one target base stations 130, are network elements and may be embodied by any of a variety of access points. For example, the base stations may be embodied by a base station, a Node B, e.g., a gNB, or the like. Additionally, the at least one database 140 may be embodied by a network device that includes any of a variety of memory devices.

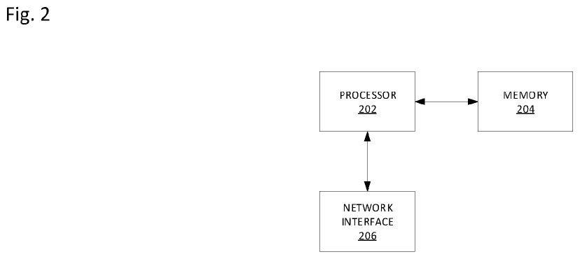

Referring now to FIG. 2, an example apparatus 200 is provided. The apparatus 200 may be an embodiment of a UE 110 and/or may be embodied by or otherwise associated with a UE 110, in some instances. Alternatively, the apparatus 200 may be an embodiment of a network element or may be embodied by or otherwise associated with a network element and, as such may embody the access point of any one of the base stations, e.g., the source base station 120 or a target base station 130, and/or may embody the database 140.

The apparatus 200 may include processor 202, memory 204, and network interface 206. The apparatus 200 may be configured to execute the operations described herein. Although these components are described with respect to the performance of various functions, it should be understood that the particular implementations necessarily include the use of particular hardware. It should also be understood that certain of these components may include similar or common hardware. For example, two sets of circuitries may both leverage use of the same processor, network interface, storage medium, or the like to perform their associated functions, such that duplicate hardware is not required for each set of circuitries.

In some embodiments, the processor 202 (and/or co-processor or any other processing circuitry assisting or otherwise associated with the processor) may be in communication with the memory 204 via a bus for passing information among components of the apparatus. The memory 204 is non-transitory and may include, for example, one or more volatile and/or non-volatile memories. In other words, for example, the memory 204 may be an electronic storage device (e.g., a computer-readable storage medium). The memory 204 may be configured to store information, data, content, applications, instructions, or the like for enabling the apparatus to carry out various functions in accordance with an example embodiment disclosed herein.

The processor 202 may be embodied in a number of different ways and may, for example, include one or more processing devices configured to perform independently. In some non-limiting embodiments, the processor 202 may include one or more processors configured in tandem via a bus to enable independent execution of instructions, pipelining, and/or multithreading. The use of the term “processor” may be understood to include a single core processor, a multi-core processor, multiple processors internal to the apparatus, and/or remote or “cloud” processors.

In some embodiments, the processor 202 may be configured to execute instructions stored in the memory 204 and/or circuitry otherwise accessible to the processor 202. In some embodiments, the processor 202 may be configured to execute hard-coded functionalities. As such, whether configured by hardware or software methods, or by a combination thereof, the processor 202 may represent an entity (e.g., physically embodied in circuitry) capable of performing operations according to an embodiment disclosed herein while configured accordingly. Alternatively, as another example, when the processor 202 is embodied as an executor of software instructions, the instructions may specifically configure the processor 202 to perform the algorithms and/or operations described herein when the instructions are executed.

In some embodiments, the apparatus 200 may optionally include input/output circuitry that may, in turn, be in communication with processor 202 to provide output to a user and/or other entity and, in some embodiments, to receive an indication of an input. The input/output circuitry may comprise a user interface and may include a display, and may comprise a web user interface, a mobile application, a query-initiating computing device, a kiosk, or the like. In some embodiments, the input/output circuitry may also include a keyboard, a mouse, a joystick, a touch screen, touch areas, soft keys, a microphone, a speaker, or other input/output mechanisms. The processor and/or user interface circuitry comprising the processor may be configured to control one or more functions of one or more user interface elements through computer program instructions (e.g., software and/or firmware) stored on a memory accessible to the processor (e.g., memory 204, and/or the like).

The network interface 206 may be any means such as a device or circuitry embodied in either hardware or a combination of hardware and software that is configured to receive and/or transmit data from/to a network and/or any other device, circuitry, or module in communication with the apparatus 200. In this regard, the network interface 206 may include, for example, a network interface for enabling communications with a wired or wireless communication network, such as the source base station 120 and one or more target base station 130. For example, the network interface 206 may include one or more network interface cards, antennae, buses, switches, routers, modems, and supporting hardware and/or software, or any other device suitable for enabling communications via a network. Additionally, or alternatively, the network interface 206 may include the circuitry for interacting with the antenna/antennae to cause transmission of signals via the antenna/antennae or to handle receipt of signals received via the antenna/antennae.

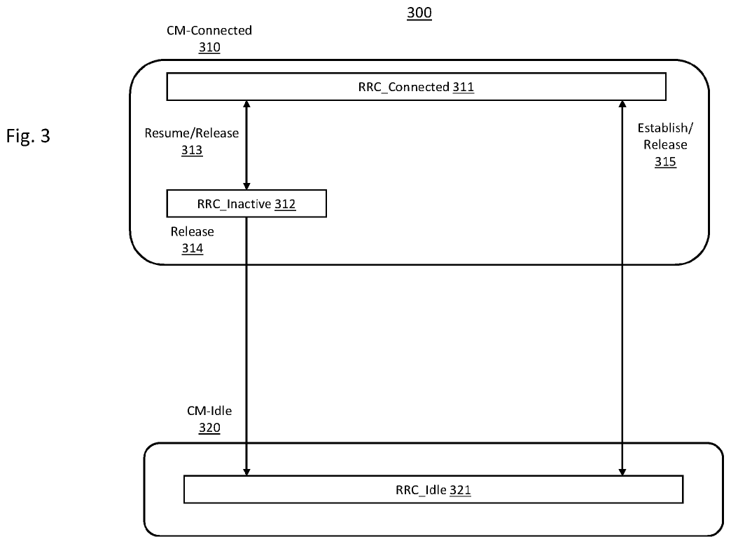

Referring to FIG. 3, an example configuration of a connection management system 300 is provided. In some embodiments, the depicted connection management system 300 may be configured to manage and/or reduce the time it takes for a user equipment (UE) to switch a radio resource control (RRC) state. With reference to FIG. 3, in various embodiments, the connection management system 300 may comprise a connection management-connected (CM-connected) 310 state and/or a connection management-idle (CM-idle) 320 state. The two connection management states (e.g., CM-connected 310 and CM-idle 320) may be defined by the 3GPP specifications. In various embodiments, the CM-connected 310 state may further comprise an RRC_Connected 311 state and/or an RRC_Inactive 312 state for a UE. The RRC_Connected 311 state and the RRC_Inactive 312 state may be used to increase power saving features of the UE, such as by entering RRC_Inactive state in order to save power in an instance in which the UE is not actively transmitting or receiving data. By maintaining the UE in the CM-Connected state while in the RRC_Inactive state, the delay of changing a connection state, such as the delay associated with changing from an RRC_Inactive state to an RRC_Connected state when data needs to be transmitted, is reduced relative to a transition from the CM-Idle state to the CM-Connected state.

With further reference to FIG. 3, in various embodiments, a user equipment (UE) may switch from an RRC_Connected 311 state to an RRC_Inactive 312 state based on a source base station, that is, the base station currently serving the UE in the RRC_Connected state, determining that the RRC state should change, such as in an instance in which the UE is not transmitting or receiving messages. The source base station may send a release signal 313 to the UE in order to switch from the RRC_Connected 311 state to the RRC_Inactive 312 state. The UE, while in the RRC_Inactive 311 state, may be configured to stay within the CM-Connected 310 state. While in the RRC_Inactive state, one or more additional signals may be provided to the UE including, for example a release 314 signal to send the UE to an RRC_Idle 321 state within an CM-Idle 320 state.

In various embodiment, a context of a user equipment (UE) may be stored on a memory device within the source base station while in the UE is in an RRC_Connected state and/or as the UE transitions from the RRC_Connected state to an RRC_Inactive state. In this regard, the source base station may transmit the context of the UE to at least one database upon releasing the UE to the RRC_Inactive state. In various embodiments, the context of the UE may comprise information associated with the specific UE, such as information required to maintain or establish network service by the UE, such as information required to maintain RAN service for the UE. The context may contain one or more of: a UE connection state information, security information, UE capability information, identities of the UE, and/or the like.

A user equipment (UE), while in an RRC_Inactive 312 state, can move within a RAN-based Notification Area (RNA) without notifying the network. The RNA can cover one or more cells and, as such, may include at least the source base station, at least one target base station, and/or at least one database. The RNA is limited to the core network registration area.

While in the RRC_Inactive state, the UE may move outside the serving area of the source base station 120. When the UE is thereafter paged or otherwise needs to transmit uplink data to the network, the UE may transmit an RRC connect request, e.g., RRC Resume Request, to at least one target base station that serves the region in which the UE is now located. In one example embodiment and as described below, the RRC connect request, e.g., RRC Resume Request, may comprise information regarding an inactive user equipment identifier (inactive UE ID), a UE inactive radio network temporary identification (I-RNTI), and/or a message authentication code (MAC) with the I-RNTI and/or the inactive UE ID having been assigned to the UE by the source base station and/or the at least one database. As used herein, the inactive UE ID includes, but is not limited to, an I-RNTI and the MAC includes, but is not limited to, a MAC-I. The target base station may, with the assistance of information provided by the database, verify the inactive UE ID and/or the I-RNTI. If the database confirms the verification of the inactive UE ID and/or the I-RNTI associated with the specific UE, the database may transmit the UE context to the target base station. The target base station may then reply to the UE with a resume signal 313 to switch the RRC connection state of the UE to an RRC_Connected state, thereby supporting network communication with the UE, such as the transmission of uplink data by the UE.

While the RRC_Inactive state 312 is beneficial for conserving power at the UE in an instance in which a UE is not transmitting uplink data for a period of time while maintaining the CM-Connected state to allow for efficient resumption of the RRC_Connected state when the UE needs to transmit uplink data, the UE is transitioned to the CM-Idle state in other scenarios. For example, with even further reference to FIG. 3, in various embodiments, the source base station and/or the one or more target base station may configure the UE to resume and/or release 313 from an RRC_Connected 311 state to an RRC_Inactive 312 state. The source base station and/or the target base station may be further configured to release 314 the UE from an RRC_Inactive 312 state to an RRC_Idle 321 state. In other instances, the source base station and/or the target base station may provide the UE with a release signal 315 to switch the UE from an RRC_Connected 311 state to an RRC_Idle 321 state.

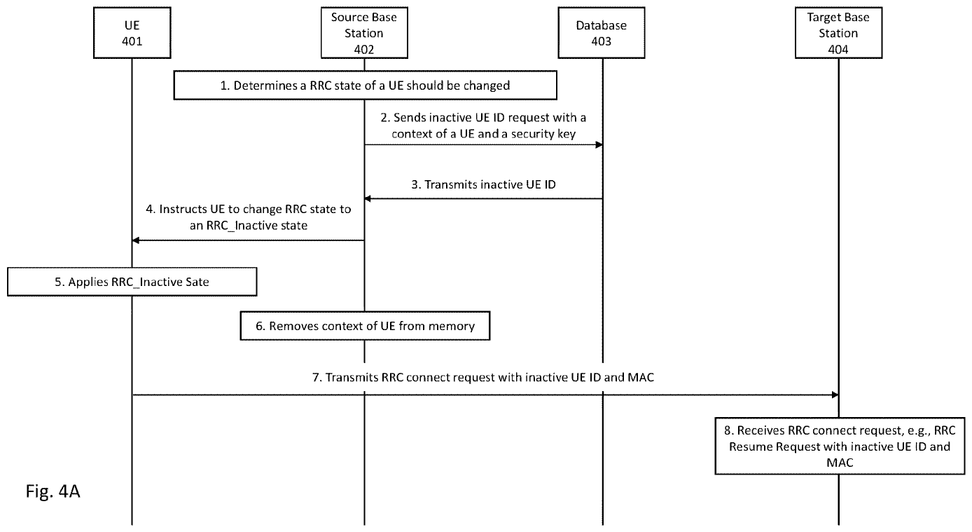

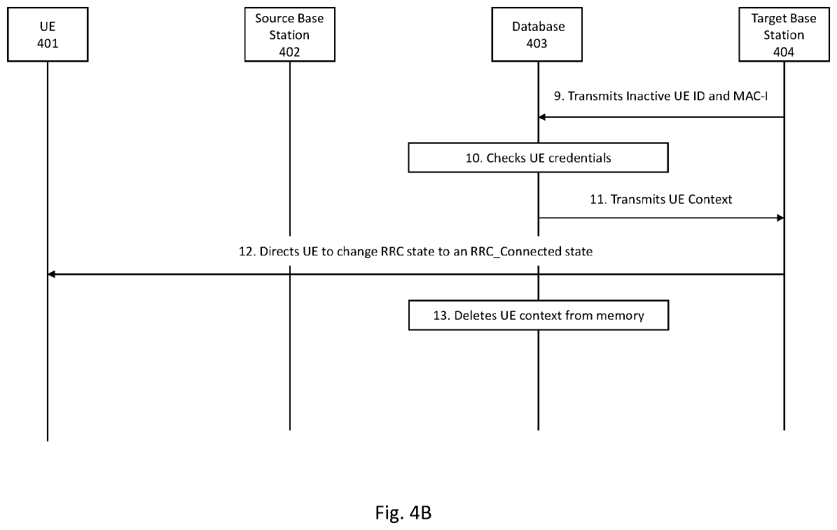

FIGS. 4A-4B illustrate an example implementation of a signal flow in accordance with various embodiments off the present disclosure, in which a source base station and/or at least one target base station may be configured to communicate with at least one database to support efficient transitioning of a user equipment (UE) between radio resource control (RRC) states while remaining in the CM-Connected state. The switching of a RRC state of the UE may be improved in accordance with various embodiments in various manners, such as providing the database for storing the context of a UE in combination with information that identifies and verifies the UE, such as a security code, e.g., a message authentication code (MAC), and/or an identifier for the UE, e.g., an inactive user equipment identifier (inactive UE ID) associated with the UE. The MAC may comprise information that is at least partially based on a security key assigned to the specific UE. The inactive UE ID may comprise information regarding a database identifier (DB ID) assigned to the UE.

As described below, in an instance in which the source base station determines that a radio resource control (RRC) state of a user equipment (UE) should be changed, such as in an instance in which the UE is not transmitting data, the source base station may be configured to provide a database with a context of the UE and/or a request for an inactive user equipment identifier (inactive UE ID). In this regard, the inactive user equipment identifier is an identifier of the UE that is inactive. The database, in response to the request, may store the context of the UE and/or generate the inactive UE ID with the inactive UE ID then being provided to the source base station and/or the UE. The UE may also be configured to subsequently initiate an RRC connect request, e.g., RRC Resume Request, such as in an instance in which the UE is paged or otherwise needs to transmit uplink data. The RRC connect request, e.g., RRC Resume Request, may be directed to at least one target base station in an instance in which the UE has left the region served by the source base station and is now in the region served by the target base station. In an instance in which the target base station receives the RRC connect request, e.g., RRC Resume Request, the target base station may be configured to transmit the inactive UE ID to the database in order to receive the context of the UE. In this regard, the network entity, such as the database, can assist with changing the RRC state of the UE with without requiring further communication between the source base station and/or the target base station and without requiring the source base station to maintain the UE context once the UE context has been stored by the database.

With reference to FIG. 4A, at operation 1, the apparatus 200 associated with the source base station 402 may include means, such as the processor 202, the memory 204, or the like, configured to determine that a radio resource control (RRC) state of at least one user equipment (UE) 401 should be changed from an RRC_Connected state to an RRC_Inactive state, such as in an instance in which the UE is not transmitting data. As shown in operation 2, in an instance in which the source base station 402 determines to change the RRC state of the UE, the source base station 402 may transmit a request to at least one database 403 for an inactive user equipment identifier (inactive UE ID) to be assigned to the specific UE 401. The source base station 402 may also transmitting the context of the UE 401 and/or a security key assigned to the UE 401 to the database 403 for storage. The context of the UE 401 may comprise information regarding a UE RRC state information, security information (e.g., security key), UE capability information, identities of the UE, an inactive radio network temporary identification (I-RNTI), a database identifier (DB ID), an inactive identifier, a message authentication code-integrity (MAC-I), and/or the like. The security key included in the context of the UE 401 may be any of a variety of security keys including a KgNB and/or information that may be used to derive the KgNB.

The at least one database 403 may receive the inactive user equipment identifier (inactive UE ID) request, the context information, and/or the security key from the source base station 402 for the respective user equipment (UE). As shown in operation 3, the apparatus 200 associated with the database 403 includes means, such as the processor 202, the memory 204, the network interface 206 or the like, for receiving and/or storing the context of the UE and the security key and transmitting the inactive UE ID to the source base station. In various embodiments, the database 403 may generate the inactive UE ID specifically for the UE 401 in response to receiving the request from the source base station. The inactive UE ID may comprise a database identifier (DB ID) associated with the UE 401. The DB ID allows for base stations (e.g., source base station, target base stations, etc.) to access the stored context of the UE within the database.

At operation 4, the apparatus 200 associated with the source base station 402 may include means, such as the processor 202, the memory 204, the network interface 206 or the like, for instructing the UE 401 to change its RRC state from an RRC_Connected state to an RRC_Inactive state with the source base station 402 in response to various triggers including, for example, the failure of the UE to transmit uplink data for a period of time. The instructing of the UE 401 to change the RRC state may comprise providing the UE 401 with the inactive UE ID assigned to to the UE. The inactive UE ID may include information regarding a database identifier (DB ID). The instructions may further comprise information regarding the security key and/or information from which the security key assigned to the UE 401 may be derived.

At operation 5, the apparatus 200 associated with the user equipment (UE) 401 may include means, such as the processor 202, the memory 204, the network interface 206 or the like, for receiving the instructions from the source base station 402 to change the radio resource control 22 (RRC) state to an RRC_Inactive state. In various embodiments, the UE 401 receives the instructions from the source base station 402 and acts upon the instructions, such that, the UE 401 switches to the RRC_Inactive state. The instructions may comprise information regarding an inactive user equipment identifier (inactive UE ID) assigned to the UE.

At operation 6, the apparatus 200 associated with the source base station 402 may include means, such as the processor 202, the memory 204, or the like, for removing the context of the user equipment 401 (UE) from its memory after the instructions to change the radio resource control (RRC) state to the RRC_Inactive state have been delivered to the UE 401. In some embodiments, the context of the UE is not purged from the memory of the source base station, but, instead, the memory location(s) that store the context are allowed to be rewritten.

At operation 7, the apparatus 200 associated with the user equipment (UE) 401 may include means, such as the processor 202, the memory 204, the network interface 206 or the like, for causing a radio resource control (RRC) connect request, e.g., RRC Resume Request, to be transmitted to at least one target base station 404 that is now serving the UE. In various embodiments, the RRC connect request, e.g., RRC Resume Request, may further cause the UE 401 to generate a security code to verify the identity of the UE, such as a message authentication code (MAC) that is generated using a security key. In various embodiment, the UE 401 may generate the MAC using at least one of the following: the inactive user equipment identifier, a source base station identifier, or a target base station identifier. The UE 401 may further transmit information to the target base station including, for example, information regarding the inactive user equipment identifier (inactive UE ID) and/or the MAC.

At operation 8, the apparatus 200 associated with the at least one target base station 404 may include means, such as the processor 202, the memory 204, the network interface 206 or the like, for receiving a radio resource control (RRC) connect request, e.g., RRC Resume Request, from the user equipment 401. The target base station 404 may further receive an inactive user equipment identifier (inactive UE ID) and/or a message authentication code (MAC) from the UE. In various embodiments, the target base station may store the inactive UE ID and/or MAC for a predetermined amount of time. At operation 9 of FIG. 4B, the target base station 404 causes the inactive UE ID and/or the MAC to be provided to at least one database 403. The MAC may comprise information at least partially based on the security key assigned to the UE 401. The information provided by the target base station, that is, the inactive UE ID and the MAC may be used by the database 403 to quickly access information (e.g., context of the UE) stored therein.

At operation 10, the apparatus 200 associated with the at least one database 403 may include means, such as the processor 202, the memory 204, the network interface 206 or the like, for receiving an inactive user equipment identifier (inactive UE ID) and/or a message authentication code (MAC) from at least one target base station 404. The database 403 may access its memory device to check and verify the inactive UE ID and/or the MAC received from the target base station 404 for the specific user equipment (UE) 401 matches the inactive UE ID previously generated by the database and the MAC that is generated based upon the security key that was previously provided to the database by the source base station.

At operation 11, the apparatus 200 associated with the at least one database 403 may include means, such as the processor 202, the memory 204, the network interface 206 or the like, for causing the information regarding the context of the user equipment (UE) 401 to be provided to the target base station 404 upon verification of the inactive user equipment identifier (inactive UE ID) and/or upon verification of the message authentication code (MAC).

At operation 12, the apparatus 200 associated with the at least one target base station 404 may include means, such as the processor 202, the memory 204, the network interface 206 or the like, for causing direction to be provide to the user equipment 401 (UE) to change the radio resource control (RRC) state to an RRC_Connected state with the target base station 404.

At operation 13, the apparatus 200 associated with the at least one database 403 may include means, such as the processor 202, the memory 204, or the like, for removing the user context of the user equipment 401 (UE) after providing the target base station 404 with the information associated with the context of the UE 401. Thus, the method depicted by FIGS. 4A and 4B provide for the efficient transition between the RRC_Connected and RRC_Inactive states without requiring the source base station to maintain the context of the UE.

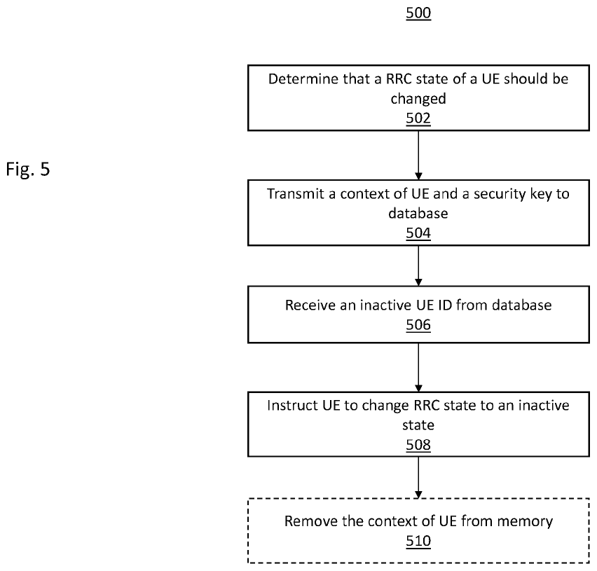

Referring now to FIGS. 5-8, example flowcharts are provided of the operations performed by an apparatus, such as the apparatus of FIG. 2 embodied by a source base station, a user equipment (UE), at least one database and/or at least one target base station, respectively. Referring now to FIG. 5, an example flowchart 500 is illustrated that can be carried out by an apparatus as embodied by the source base station with the apparatus including means, such as the processor 202, the memory 204, and the network interface 206 or the like, for determining that a radio resource control (RRC) state of a UE should be changed from an RRC_Connected state to an RRC_Inactive state, at 502. This determination may be based on various factors including, for example, that the UE is not currently transmitting uplink data.

In response to determining that the RRC state of a UE should be changed from an RRC_Connected state to an RRC_Inactive state, the apparatus also includes means, such as the processor 202, the memory 204, the network interface 206 and/or the like, for transmitting a context of a user equipment (UE) and/or a security key to the database, at 504. The apparatus embodied by the source base station may also be configured to transmit an inactive user equipment identifier (inactive UE ID) request be transmitted to at least one database, as shown in FIG. 4A.

The apparatus also includes means, such as the processor 202, the memory 204, the network interface 206 and/or the like, for receiving at least one inactive user equipment identifier (inactive UE ID) from the database for the user equipment (UE), at 506. The inactive UE ID may comprise information regarding a database identifier (DB ID) with the DB ID may uniquely identifying the UE within the database. The DB ID may allow for at least one database to quickly verify an inactive UE ID and/or retrieve the context information associated with the DB ID in order to decrease the time it takes for a target base station to establish a radio resource control (RRC) connection with the UE.

The apparatus further includes means, such as the processor 202, the memory 204, the network interface 206 and/or the like, for instructing the user equipment (UE) to change the radio resource control (RRC) state to an RRC_Inactive state, at 508. The instructing of the UE to change the RRC state may comprise causing the inactive user equipment identifier (inactive UE ID) to be provided to the UE for use, as described below, in subsequently transitioning from the RRC_Inactive state to the RRC_Connected state. In various embodiments, the instructions may further comprise the security key utilized to verify the UE to the database and/or information defining the process by which the security key can be derived.

The apparatus may optionally further include means, such as the processor 202, the memory 204, the network interface 206 and/or the like, for removing the context of the user equipment (UE) from the source base station memory, at 510. The source base station may remove the context from its memory after delivering the instructions for the UE to change radio resource control (RRC) state. In some embodiments, the source base station may remove the context of the UE from its memory after the UE has switched from an RRC_Connected state to an RRC_Inactive state. The source base station is thereafter no longer responsible for maintaining the context of the UE, as the context of the UE is now stored by the database.

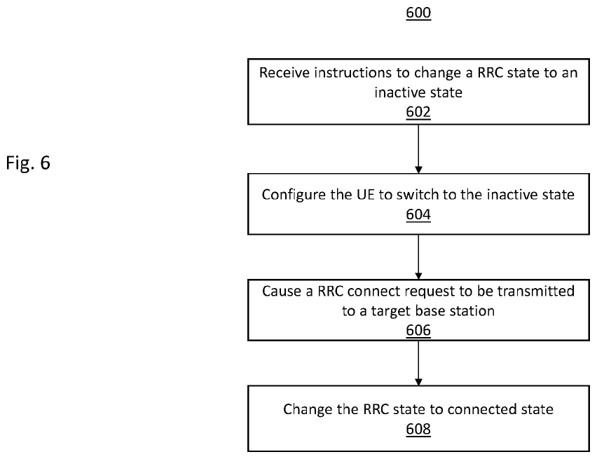

Referring now to FIG. 6, an example flowchart illustrating the operations performed, such as by an apparatus as depicted in FIG. 2 and embodied as the user equipment (UE). Referring now to FIG. 6, a method 600 is illustrated that can be carried out by an apparatus embodied by a user equipment and that comprises means, such as the processor 202, memory 204, and the network interface 206 or the like, for switching a radio resource control (RRC) state with a source base station and establishing a RRC connection with one or more target base station, as shown in the operations of FIGS. 4A-4B.

The apparatus further includes means, such as processor 202, memory 204, network interface 206 and/or the like, for receiving instructions to change a radio resource control (RRC) state to an RRC_Inactive state, at 602. The instruction may be received from a source base station (e.g., last serving base station). The instruction may comprise information regarding an inactive user equipment identifier (inactive UE ID) associated with the UE. The inactive UE ID may comprise information regarding a database identifier (DB ID) associated with the UE. The instruction may also include a security key associated with the UE or information from which the security key may be derived.

The apparatus further includes means, such as processor 202, memory 204, network interface 206 and/or the like, for configuring the user equipment (UE) to switch to an RRC_Inactive state based on the instructions from the source base station, at 604, that previously served the UE.

Sometime after transitioning to the RRC_Inactive state, the apparatus further includes means, such as processor 202, memory 204, network interface 206 and/or the like, for causing a radio resource control (RRC) connect request, e.g., RRC Resume Request, to be transmitted to a target base station, at 606, such as in response to the UE being paged or otherwise needing to transmit uplink data. The RRC connect request, e.g., RRC Resume Request, may further cause the user equipment (UE) to generate a message authentication code (MAC) using the security key in order to permit the identity of the UE to be verified. The MAC may be generated by using at least one of: the inactive user equipment identifier, a source base station identifier, or a target base station identifier. The UE may transmit the inactive user equipment identifier (inactive UE ID) associated with the UE and/or the MAC or information associated with the MAC to the target base station.

The apparatus further includes means, such as processor 202, memory 204, network interface 206 and/or the like, for changing the radio resource control (RRC) state of the user equipment (UE) to an RRC_Connected state, at 608. Prior to changing the RRC state of the UE, the UE may receive one or more instructions from the target base station with the instructions configuring the UE to establish a RRC connection with the target base station.

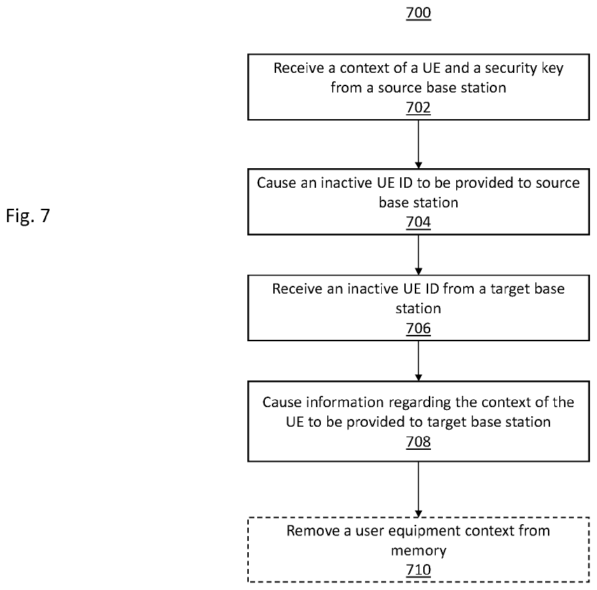

Referring now to FIG. 7, an example flowchart illustrating the operations performed, such as by an apparatus as depicted in FIG. 2 and embodied as at least one database. Referring now to FIG. 7, a method 700 is illustrated that can be caried out by an apparatus embodied by at least one database and that comprise means, such as the processor 202, memory 204, and network interface 206 or the like, for receiving a context of a user equipment (UE) and/or a security key of a UE from a source base station, at 702. The database may store the context information (e.g., a UE RRC state information, security information (e.g., security key), UE capability information, identities of the UE, an inactive radio network temporary identification (I-RNTI), a database identifier (DB ID), an inactive identifier, a message authentication code-integrity (MAC-I), and/or the like) within a memory device 204 and/or generate an inactive user equipment identifier (inactive UE ID) associated with the context of the specific UE and uniquely identifying the UE.

The apparatus embodied by at least one database further includes means, such as the processor 202, the memory 204, the network interface 206 or the like, for causing the inactive user equipment identifier (inactive UE ID) to be provided to the source base station, at 704. The inactive UE ID may comprise information regarding a database identifier (DB ID) that may be used by a target base station.

After having stored the context of the UE and in conjunction with a subsequent effort to cause the UE to transmission from an RRC_Inactive state to an RRC_Connected state, the apparatus embodied by at least one database further includes means, such as the processor 202, the memory 204, the network interface 206 or the like, for receiving the inactive user equipment identifier (inactive UE ID) from a target base station, at 706. The data may further include means for receiving information from which the identity of the UE may be verified, such as a message authentication code (MAC), from the target base station. The MAC may comprise information regarding a security key associated with and used to access the inactive UE ID. In various embodiments, the database may use the inactive UE ID, the MAC, the security key, and/or any combination thereof to access and/or verify the credentials of the specific user equipment (UE).

The apparatus embodied by at least one database further includes means, such as the processor 202, the memory 204, the network interface 206 or the like, for causing information regarding the context of the user equipment (UE) that has been stored by the database to be provided to the target base station, at 708. The database may transmit the context of the UE to the target base station after verifying the credentials that verify the UE. In an instance in which the database is unable to verify the credentials, the database may transmit an error message to the target base station.

The apparatus embodied by at least one database may optionally further include means, such as the processor 202, the memory 204, or the like, for removing the user context for the user equipment (UE) from memory, at 710. In various embodiments, the database may remove the user context of the UE from its memory after transmitting the context to the target base station. In other embodiments, the database may remove the user context of the UE after the target base station and the UE establish a radio resource control (RRC) connection.

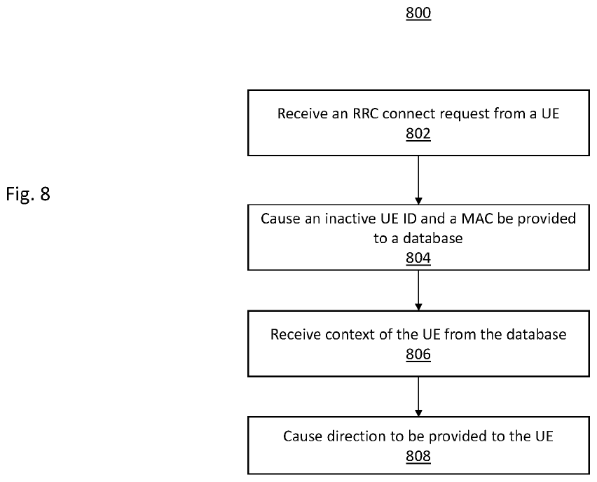

Referring now to FIG. 8, an example flowchart illustrating the operations performed, such as by an apparatus as depicted in FIG. 2 and embodied as at least one target base station. A method 800 is illustrated that can be caried out by an apparatus embodied by at least one target base station and that comprises means, such as the processor 202, memory 204, and network interface 206 or the like, for receiving a radio resource control (RRC) connect request, e.g., an RRC Resume Request, from a user equipment (UE), at 802. The RRC connect request, e.g., RRC Resume Request, may further comprise information regarding an inactive user equipment identifier (inactive UE ID) and/or information from which the identity of the UE may be verified, such as a message authentication code (MAC). In various embodiments, the inactive UE ID may comprise information regarding a database identifier (DB ID) assigned to the UE. In some embodiments, the MAC may be based at least partially on the security key assigned to the UE. In other embodiments, the MAC is also at least partially based on at least one of: the inactive user equipment identifier, a source base station identifier, or a target base station identifier.

The apparatus embodied by at least one target base station further includes means, such as the processor 202, the memory 204, the network interface 206 or the like, for causing an inactive user equipment identifier (inactive UE ID) and/or information from which the identity of the UE may be verified, such as a message authentication code (MAC), be provided to at least one database, at 804. The inactive UE ID and/or MAC may be verified by the database in order to establish a radio resource control (RRC) connection with a user equipment (UE).

The apparatus embodied by at least one target base station further includes means, such as the processor 202, the memory 204, the network interface 206 or the like, for receiving a context of the user equipment (UE), at 806. The target base station may receive the context of the UE from the database after the database verifies the credentials, such as the security, the MAC, etc. of the UE that were provided by the target base station to the database.

The apparatus embodied by at least one target base station further includes means, such as the processor 202, the memory 204, the network interface 206 or the like, for causing direction to be provided to the user equipment (UE) to change the radio resource control (RRC) state to an RRC_Connected state with the target base station, at 808. Thereafter, the UE and the target base station now serving the UE can commence communications, such as the transmission of uplink and/or downlink data therebetween.

As described above, a method, apparatus and computer program product are provided in order to facilitate an efficient transition between the RRC_Connected and RRC_Inactive states. In this regard, the context of the UE is maintained by a database while the UE is in the RRC_Inactive state. The database may be referenced by the target base station in conjunction with a transition from the RRC_Inactive state to the RRC_Connected state to obtain the UE context, even though the target base station that now serves the UE during the transition from the RRC_Inactive state to the RRC Connected state is different than the source base station that served the UE at the time that the UE previously transitioned to the RRC_Inactive state. By storing the UE context in a database, the source base station can delete the UE context such that the source base station no longer needs to maintain the resources allocated for the UE, while still ensuring that the UE can efficiently return to the RRC_Connected state at a subsequent point in time while served by the target base station. Additionally, the method, apparatus and computer program product of an example embodiment provide for the UE to be identified and for the identity of the UE to be verified in such a manner that the source base station need not track the identifiers that have been previously utilized in conjunction with UEs in an RRC_Inactive state, thereby improving the efficiency with which the source base station operates.

FIGS. 5-8 illustrate flowcharts depicting operations according to an example embodiment of the present disclosure. It will be understood that each block of the flowcharts and combination of blocks in the flowcharts may be implemented by various means, such as hardware, firmware, processor, circuitry, and/or communication devices associated with execution of software including one or more program instructions. For example, one or more of the procedures or operations described above may be embodied by computer program instructions. In this regard, the computer program instruction which embody the procedures or operations described above may be stored by a memory 204 of an apparatus (e.g., apparatus 200, UE 110, source base station 120, target base station 130, database 140) employing an embodiment of the present invention and executed by a processor 202. As will be appreciated, any such computer program instructions may be loaded onto a computer or other programmable apparatus (for example, hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart block.

Accordingly, blocks of the flowcharts support combinations of means for performing the specified functions and combinations of operations for performing the specified functions for performing the specified functions. It will also be understood that one or more blocks of the flowcharts, and combinations of blocks in the flowcharts, can be implemented by special purpose hardware-based computer systems which perform the specified functions, or combinations of special purpose hardware and computer instructions.

Many modifications and other embodiments of the present disclosure set forth herein will come to mind to one skilled in the art to which these embodiments pertain having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions can be provided by alternative embodiments without departing from the scope of the appended claims. In this regard, for example, different combinations of elements and/or functions than those explicitly described above are also contemplated as can be set forth in some of the appended claims. Although specific terms are employed herein, they are used in a generic and descriptive sense only and not for purposes of limitation.

1-64. (canceled)

65. An apparatus comprising:
at least one processor; and
at least one memory storing instructions that, when executed by the at least one processor, cause the apparatus at least to:
receive instructions to change a radio resource control state to an inactive state, wherein the instructions comprise an inactive user equipment identifier;
configure the apparatus to switch to the inactive state;
cause a radio resource control connect request to be transmitted to a target base station along with the inactive user equipment identifier and a message authentication code; and
change the radio resource control state to a connected state in response to direction from the target base station.

66. The apparatus of claim 65, wherein the apparatus further is caused to generate the message authentication code using a security key.

67. The apparatus of claim 66, wherein the instructions further comprise information regarding derivation of the security key.

68. The apparatus of claim 65, wherein the message authentication code is generated using at least one of: the inactive user equipment identifier, a source base station identifier, or a target base station identifier.

69. The apparatus of claim 65, wherein the apparatus is further caused to receive the direction to change the radio resource control state to the connected state.

70. The apparatus of claim 65, wherein the apparatus comprises or is comprised in a user equipment.

71. A method comprising:
receiving, by a user equipment, instructions to change a radio resource control state to an inactive state, wherein the instructions comprise an inactive user equipment identifier;
configuring the user equipment to switch to the inactive state;
causing a radio resource control connect request to be transmitted to a target base station along with the inactive user equipment identifier and a message authentication code; and
changing the radio resource control state to a connected state in response to direction from the target base station.

72. The method of claim 71, further comprising generating the message authentication code using a security key.

73. The method of claim 72, wherein the instructions further comprise information regarding derivation of the security key.

74. The method of claim 71, wherein the message authentication code is generated using at least one of: the inactive user equipment identifier, a source base station identifier, or a target base station identifier.

75. The method of claim 71, further comprising receiving the direction to change the radio resource control state to the connected state.

76. An apparatus comprising:
at least one processor; and
at least one memory storing instruction that, when executed by the at least one processor, cause the apparatus at least to:
determine that a radio resource control state of a user equipment should be changed;
cause a context of the user equipment and a security key to be transmitted to at least one database;
receive an inactive user equipment identifier from the at least one database; and
instruct the user equipment to change the radio resource control state to an inactive state by causing the inactive user equipment identifier to be provided to the user equipment.

77. The apparatus of claim 76, wherein the apparatus is further caused to request for the inactive user equipment identifier to be provided to the at least one database.

78. The apparatus of claim 76, wherein the inactive user equipment identifier comprises an identifier of the at least one database.

79. The apparatus of claim 76, wherein the apparatus is further caused to remove the context of user equipment from memory after instructing the user equipment to change the radio resource control state to the inactive state.

80. The apparatus of claim 76, wherein the apparatus is caused to instruct the user equipment to change the radio resource control state to the inactive state by causing information regarding derivation of a security key to be provided to the user equipment.

81. The apparatus of claim 76, wherein the inactive state comprises an RRC_INACTIVE state of a CM-CONNECTED state.

82. The apparatus of claim 76, wherein the apparatus comprises or is comprised in a base station.
